(19) United States
(12) Patent Application Publication
(10) Pub. No.: US 2021/0201334 A1
(43) Pub. Date: Jul. 1, 2021

(54) MODEL ACCEPTABILITY PREDICTION SYSTEM AND TECHNIQUES

(71) Applicant: Capital One Services, LLC, McLean, VA (US)

(72) Inventors: Austin Grant WALTERS, Savoy, IL (US); Galen RAFFERTY, Mahomet, IL (US); Vincent PHAM, Champaign, IL (US); Reza FARIVAR, Champaign, IL (US); Jeremy Edward GOODSITT, Champaign, IL (US); Anh TRUONG, Champaign, IL (US); Mark Louis WATSON, Sedona, AZ (US)

(73) Assignee: Capital One Services, LLC, McLean, VA (US)

(21) Appl. No.: 16/731,516

(22) Filed: Dec. 31, 2019

(51) Int. Cl. G06Q 30/02; G06Q 40/02; G06N 3/08; G06F 17/18

(52) U.S. Cl. CPC G06Q 30/0201; G06F 17/18; G06N 3/08; G06Q 40/025

(57) ABSTRACT

At least one non-transitory computer-readable medium comprising a set of instructions that, in response to being executed on a computing device, cause the computing device to: receive a model to be reviewed, the model comprising a plurality of categories, including: a set of input parameters, a model type, or a data profile; train a computing system to predict acceptability of the model based upon the plurality of categories; generate an acceptability prediction for the model; send the acceptability prediction for storage in a non-volatile computer-readable medium; and return the acceptability prediction for output at a user interface.

### TECHNICAL FIELD

Embodiments herein generally relate to building consumer models, and in particular to evaluating new models.

### BACKGROUND

Organizations, including, for example, financial service providers, health care providers, and corporations employ models including consumer models, credit score models, credit decision models, and such, to inform decision-making in such organizations.

In one example, financial services companies continually may create and update scoring models for a variety of activity including loan decisions (loan eligibility model), credit evaluation, and so forth. Custom models may be constructed to help predict the likelihood that a consumer will accept a credit card offer, become a profitable customer, stay current with bill payments, or declare bankruptcy.

In the fields of financial services and health care, for example, in order to deploy a given model, regulatory approval may be needed, such as from an outside regulatory body. Because such models may be relatively complex, a priori prediction may be difficult as to whether a new model will be understandable and approved by the relevant regulatory body. Thus, effort may be expended to promulgate a new model that does not result in approval, preventing the model from being deployed.

With respect to these and other considerations, the present disclosure is provided.

### BRIEF SUMMARY

In one embodiment, at least one non-transitory computer-readable medium includes a set of instructions that, in response to being executed on a computing device, cause the computing device to: receive a model to be reviewed, the model comprising a plurality of categories, including: a set of input parameters, a model type, or a data profile; train a computing system to predict acceptability of the model based upon the plurality of categories; generate an acceptability prediction for the model; send the acceptability prediction for storage in a non-volatile computer-readable medium; and return the acceptability prediction for output at a user interface.

In a further embodiment, a system is provided, including a storage device. The system may include logic, at least a portion of the logic implemented in circuitry coupled to the storage device. The logic may be arranged to receive a model to be reviewed, the model comprising a plurality of categories, including: a set of input parameters, a model type, or a data profile; train a neural network to predict acceptability of the model based upon the plurality of categories; generate an acceptability prediction for the model; and send the acceptability prediction for storage in a non-volatile computer-readable medium.

In another embodiment, a method may include receiving a model to be reviewed, where the model includes a plurality of categories, including: a set of input parameters, a model type, or a data profile. The method may include training a computing system to predict acceptability of the model based upon the plurality of categories; generating an acceptability prediction for the model; and sending the acceptability prediction for storage in a non-volatile computer-readable medium.

### BRIEF DESCRIPTION OF THE DRAWINGS

FIG. 1 illustrates an embodiment of a system.

FIG. 2 illustrates another embodiment of a system;

FIG. 3 illustrates an embodiment of a model clustering component;

FIG. 4 illustrates an embodiment of the operation of an acceptability prediction component;

FIG. 5 illustrates an embodiment of a first logic flow.

FIG. 6 illustrates an embodiment of a second logic flow.

FIG. 7 illustrates an embodiment of a third logic flow.

FIG. 8 illustrates an embodiment of a fourth logic flow.

FIG. 9 illustrates an embodiment of a computing architecture.

### DETAILED DESCRIPTION

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

The present embodiments provide systems and techniques that facilitate evaluation of models, such as consumer scoring models, health care customer models, and other models. Various embodiments involve systems and techniques to predict acceptability of a given model, (the term “explainablility” may be used herein interchangeably with the term “acceptability”) and provide further feedback, such as recommendations regarding the given model. As used herein with respect to models, the term “acceptability” may refer to qualities of understandability (comprehension) and approval by a body, such as a regulatory body. The probability of acceptability (or probability of explainability) may accordingly refer to the likelihood that a given model will be understood (comprehended) and approved by a body.

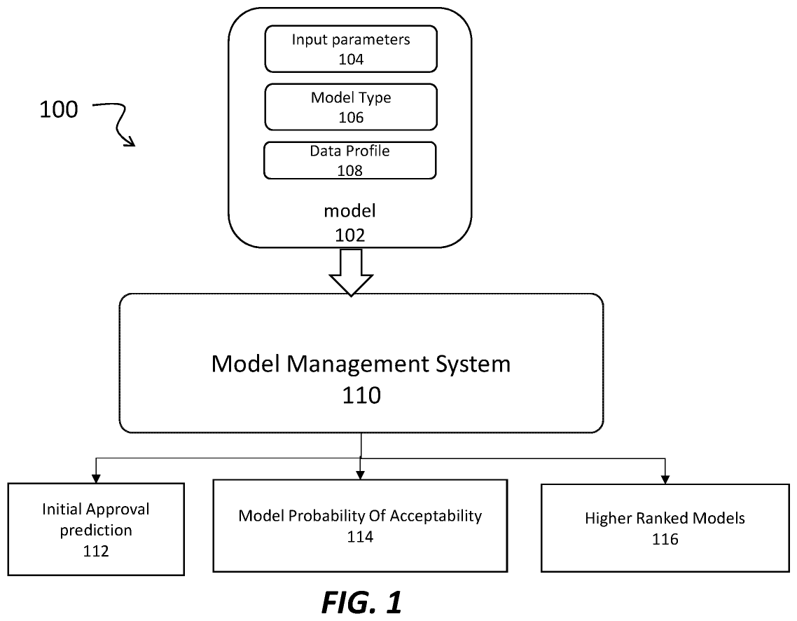

FIG. 1 depicts a schematic of operation of an exemplary system, labeled as model management system 110. In the arrangement 100, the model management system is arranged to receive a model, where the model may represent a tool for decision-making, such as for a financial institution, a medical services provider, an insurer, and so forth. In different examples, the model may be one of a: health care patient model, a financial customer model, a governmental model, and a commercial customer model. The model 102 may represent an unreviewed model, meaning a new model, not previously reviewed or included as part of the model management system 110.

In some embodiments, the model 102 may be an unsupervised model. In this regard, an unsupervised model may be based on unsupervised learning, meaning a type of machine learning where a machine discerns characteristics of the data without being given labels or values to validate itself against.

In various embodiments, the model 102 may include a set of procedures, including algorithms, designed to receive input, such as consumer information, and generate an output, such as a loan decision, or any suitable output. As such, a model may be embodied in a non-transitory computer readable storage medium. The model may involve a set of input parameters, and may be based upon a data profile suitable for the type of model. For example, different model types may be appropriate for different organizations, and for different activities, such as loan applications, or health insurance decisions.

Thus, in the example of FIG. 1, the model 102 is shown to include input parameters 104, a model type 106, and a data profile 108. Examples of a type of model or model type include a model based upon. linear regression, logistic regression, random forest, xgboost, SVM, neural network such as CNN, RNN, and so forth. The embodiments are not limited in this context. In non-limiting embodiments a data profile may include both a statistical description of the dataset (i.e. histogram, cumulative distribution function, mean, model, vocab, min, max, etc.) as well as categorization of the dataset (i.e. credit card #s, social security number, phone numbers, NPI data, etc.

Input parameters 104 may represent input parameters to a model. As an example: (vector of integers, vector of floats). In another example, input parameters may be characterized as Model([“input name”, input value type], [“input name”, input value type]).

In operation according to the present embodiments, the model 102 may be submitted to or entered into the model management system 110. Responsive to receiving the model 102, and as detailed in embodiments to follow, the model management system 110 may generate various outputs, such as an initial approval prediction 112. An initial approval prediction. Another example of the output of model management system 110 is may include an assessment of the probability of acceptability 114, as defined above. A further example of the output of the model management system, is an output of a listing of higher ranked models 116, discussed in more detail below.

In various embodiments, the model management system 110 may be implemented in a suitable combination of hardware and software. For example, the model management system 110 may be implemented in hardware such as a computer, workstation, notebook device, smartphone, etc., presenting a user interface to allow input, such as input of one or more models. The model management system 110 may be implemented across multiple computing entities, such as servers, computers, or the like, across any suitable network.

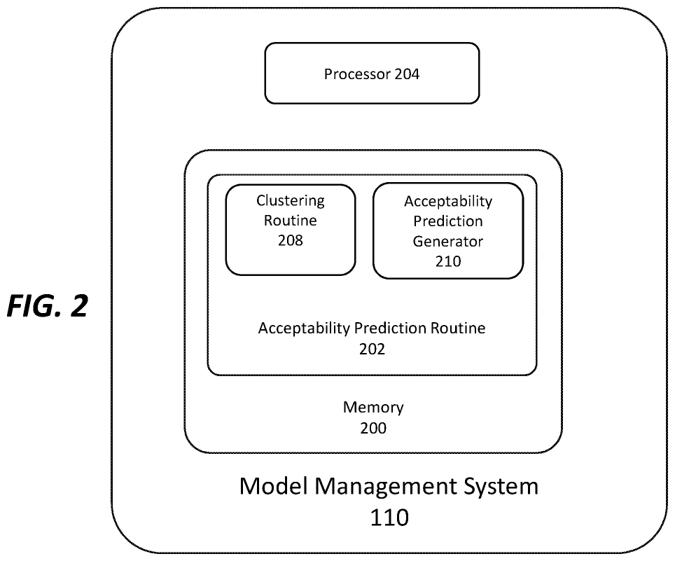

The model management system 110 may include various components to process a model and to generate the various outputs, such as those discussed above. FIG. 2 illustrates a schematic depiction of a variant of the model management system 110, including a processor 204, such as a microprocessor, dedicated logic processor, and a memory 200, such as a non-transitory computer readable storage medium, storing an acceptability prediction routine 202. The acceptability prediction routine 202 may include a clustering routine 208, where variants of the clustering routine 208 are discussed below. In brief, the clustering routine may organize information from a set of reviewed models in order to cluster information and compare this clustered information to information from the model to aid in acceptability prediction for the model.

The acceptability prediction routine may include an acceptability prediction generator 210, to generate acceptability information based upon the clustered information. As such, these components may receive a model to be reviewed, where the model includes a plurality of categories, such as a set of input parameters, a model type, and a data profile. More particularly, the acceptability prediction routine 202 may be operable on the processor 204 to train a computing system via the acceptability prediction generator 210 to predict acceptability of the model based upon one or more categories of the plurality of categories of the received model, and generate an acceptability prediction for the model. In some implementations, the acceptability prediction routine 202 may also send the acceptability prediction for storage in a non-volatile computer-readable medium.

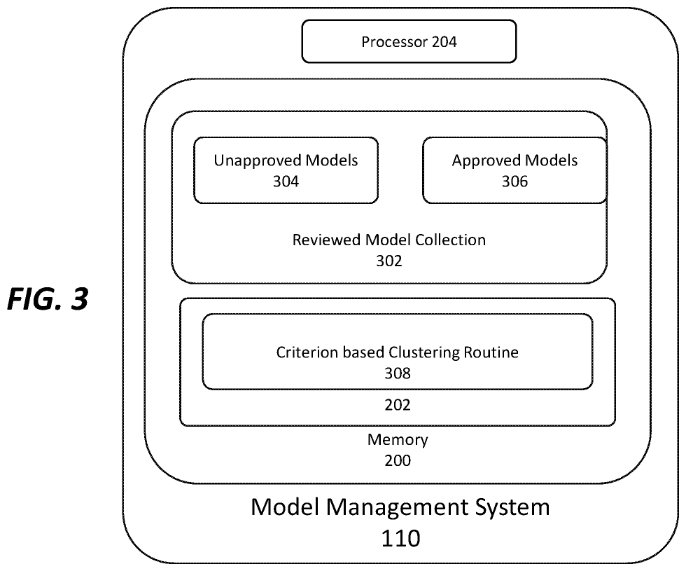

According to various embodiments, the model management system 110 may employ previously stored information, including a database of models, to process and evaluate a new model, such as an unsupervised model. According to an implementation in FIG. 3, the model management system 110 includes information or data in a memory 200, shown as a reviewed model collection 302, which data may represent data from reviewed models developed by an organization. The data in reviewed model collection 302 may include entities such as input parameters, model type, and a data profile. The data of reviewed model collection 302 may include an unapproved model collection 304 and an approved model collection 306. The unapproved model collection 304 may include data from one or more previously processed models that were not approved by a regulatory body, for example. Conversely, the approved model collection 306 may include data from one or more previously processed models that were approved by a regulatory body, for example.

Also depicted in FIG. 3, the model management system 110 may further include a criterion based clustering routine 308, operative on the processor 202 to cluster data from model management system 110 into various categories. As an example the criterion based clustering routine may interrogate or receive existing data from reviewed model collection 302 to cluster the existing data into various categories, including model type, input parameters, as well as data profile. The clustering may take place by mining information from models in both unapproved model collection 304 and approved model collection 306. The clustering may take place by clustering information from just the unapproved model collection 304, and/or clustering information from just the approved model collection 306. In the former case, the clustered information across both unapproved model collection 304 and approved model collection 306 may be compared to the information of a model. In the latter case, the information from unapproved model collection 304 and approved model collection 306 may be separately compared to the model.

According to embodiments of the disclosure, once information from reviewed model collection 302 is clustered into various categories, the model management system 110 may operate to predict whether the model will be approved, based upon categories of the model, such as data profile, model type, and input parameters. According to various embodiments of the disclosure, the model management system 110 may train a neural network, such as a convolutional neural network, CNN, or recurrent neural network, RNN to predict approval of the model. Such a neural network may be arranged as in known neural networks, where the neural network includes a large number of processing elements, either arranged as separate hardware elements, or arranged as separate programs or algorithms. The neural network may be deemed a massively parallel distributed processor where each element operates asynchronously. One known feature of neural networks is the “trainability,” which feature may be harnessed to train the neural network to predict acceptability of a model based upon clustered information from the reviewed model collection 302. As such, the neural network (not separately shown) may form a part of the model management system 110. Moreover, the processor 204 of model management system 110 may represent a plurality of different hardware processors arranged in a neural network in some embodiments.

As noted, once information from the reviewed model collection 302 is properly clustered, the model management system 110, such as via a neural network, may perform one or more operations to determine a probability of acceptability of the customer model. As noted, the acceptability prediction generator 210 may operate to predict acceptability of the model based upon the plurality of categories of the received model. By comparing the information of the model to relevant reviewed models, an acceptability probability may be generated.

In one embodiment, where the model is an unsupervised model, a query string for the unsupervised model A may be:
search->(input parameters, model type, data profile)
return->(“explainable probability”, [model A]).

The above example will apply when just an unsupervised method (unsupervised technique) is employed. In other embodiments, a CNN/RNN routine may be performed on a cluster determined by an unsupervised model. In other words, cluster determination may be determined by an unsupervised technique, while explainable probability is determined by a supervised model approach, using a neural network, for example.

In some implementations, the model management system 110 may operate to produce a set of recommendations to generate a more acceptable customer model, when the probability of acceptability of the model is below a threshold.

In other words, if the model management system 110 determines that the probability of acceptability is low, based upon comparison of categories of the model to those of the reviewed model collection 302, the model management system 110 may then automatically generate additional information, such as an indication of more appropriate models having a higher probability of acceptability, discussed in more detail below.

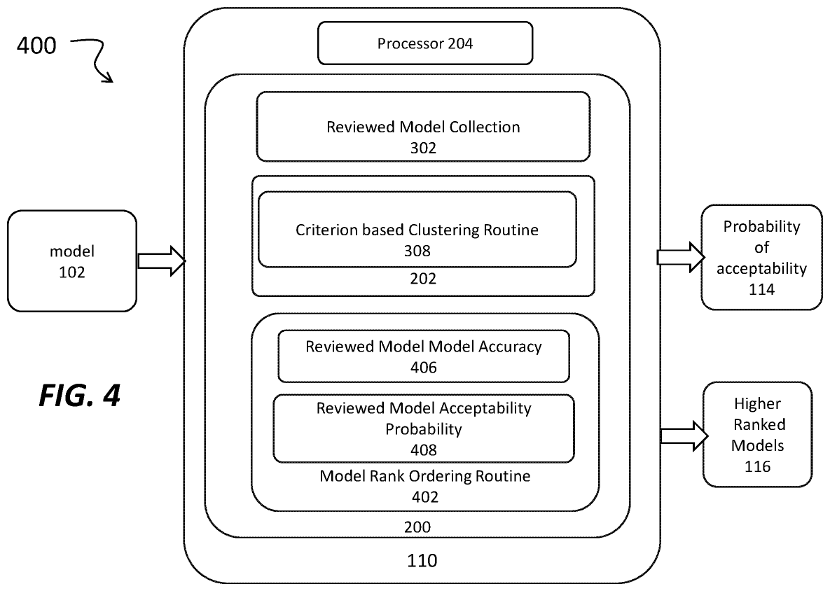

FIG. 4 illustrates more details of an embodiment of the operation of the model management system 110. In addition to the criterion based clustering routine 308, and acceptability prediction routine 202, the model management system 110 may include a model rank ordering routine 402. The model rank ordering routine 402 may operate to generate and output a set of models, such as a set of higher ranked models than the model. The model rank ordering routine 402 may further output a list of models according to a rank ordering, as defined below. The model rank ordering routine 402 may include a reviewed model model accuracy component 406, providing an accuracy metric for reviewed models of the reviewed model collection 302. The model rank ordering routine 402 may also include a reviewed model acceptability component 408, providing an acceptability probability for reviewed models. As such, using the reviewed model model accuracy component 406 and the reviewed model acceptability component 408, the model rank ordering routine 402 may generate a rank order of model type for a plurality of reviewed models by calculating an approval metric based upon an acceptability probability and a model accuracy for a plurality of reviewed models.

Notably, in an unsupervised model approach, clustering of the models is based on their similarities and providing a ranking as a result. However, in approaches using a CNN/RNN, the reviewed models may be used to train the given CNN/RNN within the cluster, while any input being evaluated is processed through the model to determine final explainability (acceptability), rather than just probability of the given cluster.

When an approval metric is determined for each of a plurality of reviewed models, the model rank ordering routine 402 may perform a rank ordering of a plurality of model types according to the approval metric for each reviewed model, such as from low to high or high to low.

An example of a query for a set of reviewed models may be:
search->(input parameters, model type, data profile)
return->(“acceptability probability”, [model type 1, model type 2, model type 3]),
   where the listing of model types is in rank order, as defined above.

Notably, in different embodiments a rank ordering may be performed with just reviewed models, or may be performed to include the reviewed models as well as a previously unreviewed model.

Thus, in operation, the model management system 110 may cluster a group of reviewed models, representing models that may potentially solve a problem. Ranking of the reviewed models is then performed based upon a combination of acceptability (explainability) and accuracy in one implementation. In another implementation, ranking of the reviewed models may be performed based upon a first operation that orders according to acceptability, where any reviewed models below a given accuracy threshold are excluded. In a further implementation, the reviewed models may be ranked according to accuracy, where any reviewed models below a given acceptability threshold are excluded.

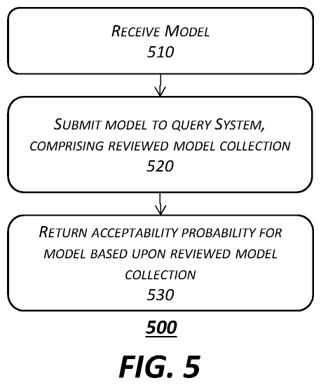

FIG. 5 illustrates an embodiment of a first logic flow, shown as logic flow 500. At block 510, a model is received, where the model represents a model as detailed hereinabove. As such, the model represents a model may represent model requiring regulatory approval before use, where the model has not yet been approved by a regulatory body.

At block 520, the model is submitted to a query system, where the query system may be a model management system, generally as detailed hereinabove. More particularly, the query system may include a database or collection of reviewed models. The reviewed model collection may include both approved models and unapproved models.

At block 530, an acceptability probability for the model is returned, where the acceptability probability represents a probability that the model will be understood and approved by a relevant regulatory body. As such, the determination of acceptability probability for the model is based upon information from the reviewed model collection, including a plurality of categories of information. The returning the acceptability probability may involve sending the acceptability probability for storage in a non-transitory computer readable medium, or may involve sending the acceptability probability for display, for example on an electronic display.

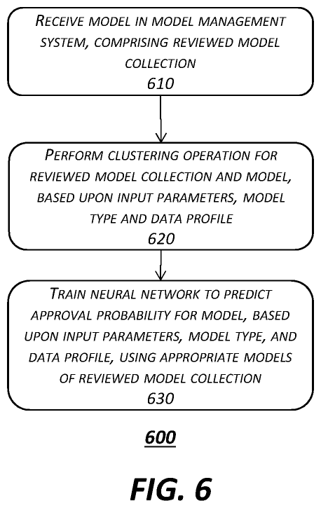

FIG. 6 illustrates an embodiment of a second logic flow, shown as logic flow 600. At block 610, a model is received in a model management system, where the model represents a model as detailed hereinabove. As such, the model may include a reviewed model collection composed of previously reviewed models, including approved models and unapproved models.

At block 620, a clustering operation is performed for the reviewed model collection and model. As such, information from the different models may be clustered into categories such as clustering based on input parameters, model type, and data profile.

At block 630, a neural network is trained to predict probability of approval of the model by a regulatory body, based upon the clustered information from the different models, including input parameters, model type, and data profile, using appropriate models of reviewed model collection. The appropriate models may be models having similar characteristics to the model, based upon the input parameters, model type, and data profile.

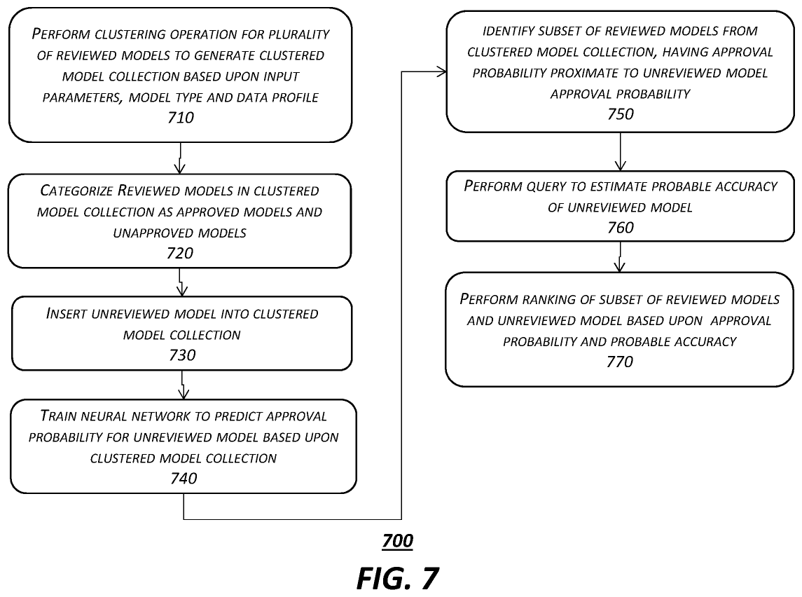

FIG. 7 illustrates an embodiment of a third logic flow, shown as logic flow 700.

At block 710, a clustering operation is performed for a plurality of reviewed models, to generate a clustered model collection. The clustered model collection may be based upon one or more features, including input parameters, model type, as well as a data profile.

At block 720, the reviewed models in the clustered model collection are categorized into approved models and unapproved models, based upon the prior fate of the reviewed models.

At block 730, an unreviewed model is inserted into the clustered model collection.

At block 740, a neural network is trained to predict approval probability of the unreviewed model based upon the clustered model collection.

At block 750, a subset of reviewed models is identified from the clustered model collection, based upon having an approval probability that is close to the approval probability of the unreviewed model. In some embodiments, the approval probability may be within 5% of the approval probability of the predicted unreviewed model, within 10%, or within 20%. The embodiments are not limited in this context.

At block 760, a query is performed to estimate the probable accuracy of the unreviewed model.

At block 770, a ranking is performed of the subset of reviewed models and the unreviewed model based upon an approval probability and probable accuracy for each model.

An advantage provided by the logic flow 700 is the ability to insert all the models gathered into a given cluster collection (even from so called hyperparameter tuning, aka different model configurations/architectures). This ability allows pseudo-hyperparameter tuning for “explainability” (“acceptability”), by identifying models having a high accuracy, while also having a reasonable chance of being “approved” by a targeted organization. Moreover, further hyperparameter tuning can be performed to further improve the model's accuracy, while still maintaining the “explainability” aspect of the model (where true samples/labels may be subsequently applied to what the targeted organization decides).

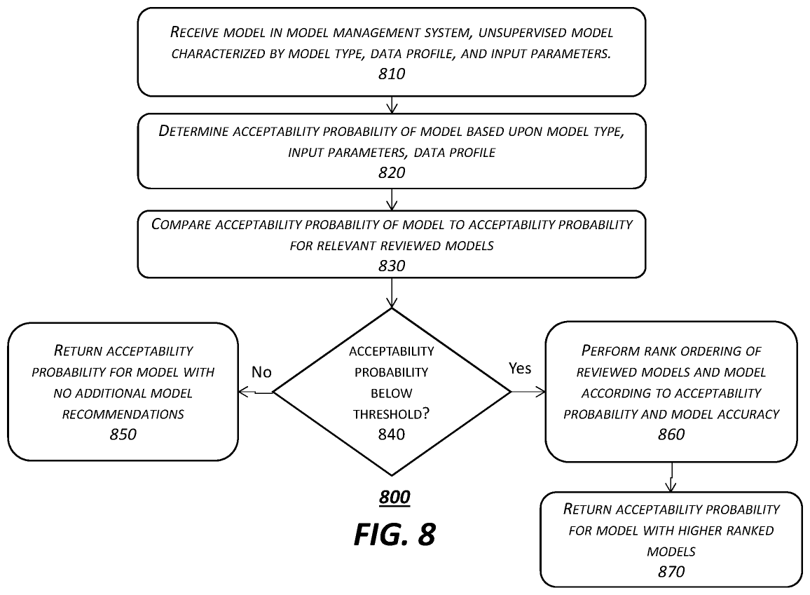

FIG. 8 illustrates an embodiment of a fourth logic flow, shown as logic flow 800. The flow proceeds at block 810, where a model is received in a model management system, where the model is characterized by a model type, a data profile, and a set of input parameters.

At block 820, an acceptability probability is determined for the model by the model management system. The acceptability determination may be based upon the model type, input parameters, and data profile. For example, a reviewed model database or collection of the model management system may be queried to help predict the acceptability probability of the model, by comparing the information and structure of the model to reviewed models. The reviewed model collection may include both (previously) approved models as well as unapproved models, and information of relevant models of the reviewed model collection may be clustered, such as model type, data profile, and input parameters. Once an acceptability probability of the model is determined, the flow moves to block 830.

At block 830 the acceptability of the model is compared to that of relevant reviewed models. The flow then moves to decision block 840.

At decision block 840, a determination is made as to whether the acceptability probability calculated for the model is below a threshold. If not, the flow moves to block 850, where the acceptability probability for the model is returned, with no additional recommendations. If so, the flow proceeds to block 860. For example, a threshold may be set at 75%, where models deemed to have less than 75% acceptability probability trigger intervention.

At block 860, a rank ordering is performed on the reviewed models, as well as the model. The rank ordering may be determined by determining a combination of acceptability probability as well as model accuracy for each higher ranked model.

At block 870, the acceptability probability of the model is returned, in addition to information from higher ranked models of the reviewed model database, such as a rank ordering of the higher ranked models.

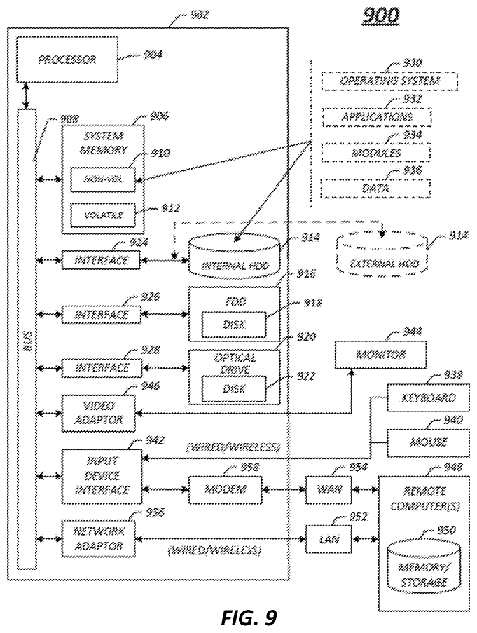

FIG. 9 illustrates an embodiment of a computing architecture 900 comprising a computing system 902 that may be suitable for implementing various embodiments as previously described. In various embodiments, the computing architecture 900 may comprise or be implemented as part of an electronic device. In some embodiments, the computing architecture 900 may be representative, for example, of a system that implements one or more components of the model management system 110. More generally, the computing architecture 900 is configured to implement all logic, applications, systems, methods, apparatuses, and functionality described herein with reference to FIGS. 1-8.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing system 902 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing system 902.

As shown in FIG. 9, the computing system 902 comprises a processor 904, a system memory 906 and a system bus 908. The processor 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi-processor architectures may also be employed as the processor 904.

The system bus 908 provides an interface for system components including, but not limited to, the system memory 906 to the processor 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computing system 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies. The computing system 902 is generally is configured to implement all logic, systems, methods, apparatuses, and functionality described herein with reference to FIGS. 1-8.

The drives and associated computer-readable media provide volatile and/or nonvolatile storage of data, data structures, computer-executable instructions, and so forth. For example, a number of program modules can be stored in the drives and memory units (910, 912), including an operating system 930, one or more application programs 932, other program modules 934, and program data 936. In one embodiment, the one or more application programs 932, other program modules 934, and program data 936 can include, for example, the various applications and/or components of the model management system 110.

A user can enter commands and information into the computing system 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computing system 902. In addition to the monitor 944, a computer typically includes other peripheral output devices, such as speakers, printers, and so forth.

The computing system 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computing system 902, although, for purposes of brevity, just a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computing system 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computing system 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computing system 902, or portions thereof, can be stored in the remote memory/storage device 950. It will be appreciated that the network connections shown are exemplary and other means of establishing a communications link between the computers can be used.

The computing system 902 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. At least one non-transitory computer-readable medium, comprising a set of instructions that, in response to being executed on a computing device, cause the computing device to:
receive a model to be reviewed, the model associated with at least one of: a set of input parameters, a model type, or a data profile;
determine a set of reviewed models comprising approved models and unapproved models, the approved models having been approved by a regulatory body, and the unapproved models having been disapproved by the regulatory body, and each of the reviewed models comprising a respective second set of input parameters, a second model type, and a second data profile;
perform a clustering operation to cluster the set of reviewed models using the respective second sets of input parameters, the second model type and the second data profile;
train a neural network with the clustered set of reviewed models to predict acceptability of the model;
generate an acceptability prediction comprising a probability for the received model by processing the received model through the neural network;
store the acceptability prediction in a memory;
determine whether the probability of acceptability for the received model is greater than an acceptability threshold;
in response to the determination the probability of acceptability is greater than the acceptability threshold, include the received model as an approved model in the set of review models;
in response to the determination the probability of acceptability is not greater than the acceptability threshold, include the received model as an unapproved model in the set of review models; and
return the acceptability prediction and an indication as to whether the received model is approved or unapproved for output at a user interface.

2. The at least one non-transitory computer-readable medium of claim 1, the set of instructions to:
in response to the probability of acceptability being equal to or below the acceptability threshold, produce a set of recommendations to generate a model to be approved; and
send the set of recommendations to output at the user interface.

3. (canceled)

4. The at least one non-transitory computer-readable medium of claim 1, the neural network comprising a convolutional neural network or a recurrent neural network.

5. The at least one non-transitory computer-readable medium of claim 1, the set of instructions to generate a rank order of model type by:
calculating an approval metric based upon of the probability of acceptability and a model accuracy for a plurality models; and
performing a rank ordering of a plurality of model types according to the approval metric.

6. The at least one non-transitory computer-readable medium of claim 1, the model comprising one of a: health care patient model, a financial customer model, a governmental model, and a commercial customer model.

7. The at least one non-transitory computer-readable medium of claim 1, the model comprising a credit decision model or a loan eligibility model.

8. The at least one non-transitory computer-readable medium of claim 1, the set of instructions to generate the acceptability prediction by determining a probability of comprehension and approval by the regulatory body associated with the model.

9-20. (canceled)

21. A system, comprising:
a storage device; and
logic, at least a portion of the logic implemented in circuitry coupled to the storage device, the logic to:
receive a model to be reviewed, the model associated with at least one of a set of input parameters, a model type, or a data profile;
determine a set of reviewed models comprising approved models and unapproved models, the approved models having been approved by a regulatory body, and the unapproved models having been disapproved by the regulatory body, and each of the reviewed models comprising a respective second set of input parameters, a second model type, and a second data profile;
perform a clustering operation to cluster the set of reviewed models using the respective second sets of input parameters, the second model type and the second data profile;
train a neural network with the clustered set of reviewed models to predict acceptability of the model;
generate an acceptability prediction comprising a probability of acceptability for the received model by processing the received model through the neural network;
store the acceptability prediction in a memory;
determine whether the probability of acceptability for the received model is greater than or equal to an acceptability threshold;
in response to the determination the probability of acceptability is greater than or equal to the acceptability threshold, include the received model as an approved model in the set of review models;
in response to the determination the probability of acceptability is not greater than the acceptability threshold, include the received model as an unapproved model in the set of review models; and
return the acceptability prediction and an indication as to whether the received model is approved or unapproved for output at a user interface.

22. The system of claim 21, the logic to:
determine the probability of acceptability is below a threshold;
in response to the probability of acceptability be below the threshold, produce a set of recommendations to generate a model to be approved; and
send the set of recommendations to output at the user interface.

23. The system of claim 21, the neural network comprising a convolutional neural network or a recurrent neural network.

24. The system of claim 21, the logic to generate a rank order of model type by:
calculating an approval metric based upon of the probability of acceptability and a model accuracy for a plurality of customer models; and
performing a rank ordering of a plurality of model types according to the approval metric.

25. The system of claim 21, the model comprising one of a: health care patient model, a financial customer model, a governmental model, and a commercial customer model.

26. The system of claim 21, the model comprising a credit decision model or a loan eligibility model.

27. The system of claim 21, the logic to generate the acceptability prediction by determining a probability of comprehension and approval by the regulatory body associated with the model.

28. A computer-implemented method, comprising:
receiving a model to be reviewed, the model associated with at least one of a set of input parameters, a model type, or a data profile;
determining a set of reviewed models comprising approved models and unapproved models, the approved models having been approved by a regulatory body, and the unapproved model having been disapproved by the regulatory body, and each of the reviewed models comprising a respective second set of input parameters, a second model type, and a second data profile;
performing a clustering operation to cluster the set of reviewed models using the respective second sets of input parameters, the second model type and the second data profile;
train a neural network with the clustered set of reviewed models to predict acceptability of the model;
generating an acceptability prediction comprising a probability of acceptability for the received model by processing the received model through the neural network;
storing the acceptability prediction in a memory;
determining whether the probability of acceptability for the received model is greater than an acceptability threshold;
in response to determining the probability of acceptability is greater than the acceptability threshold, include the received model as an approved model in the set of review models;
in response to determining the probability of acceptability is not greater than the acceptability threshold, do not include the received model as an unapproved model in the set of review models;
returning the acceptability prediction and an indication as to whether the received model is included in the set of review models or not in the set of review models for output at a user interface.

29. The computer-implemented method of claim 28, comprising:
in response to the probability of acceptability not being greater than the acceptability threshold, producing a set of recommendations to generate a model to be approved; and
causing presentation of the set of recommendations to output at the user interface.

30. The computer-implemented method of claim 28, comprising generating a rank order of model type by:
calculating an approval metric based upon of the probability of acceptability and a model accuracy for a plurality of customer models; and
performing a rank ordering of a plurality of model types according to the approval metric.

31. The computer-implemented method of claim 28, the neural network comprising a convolutional neural network or a recurrent neural network.

32. The computer-implemented method of claim 28, the model comprising one of a: health care patient model, a financial customer model, a governmental model, and a commercial customer model.

33. The computer-implemented method of claim 28, the model comprising a credit decision model or a loan eligibility model.
